(19) United States
(12) Patent Application Publication
(10) Pub. No.: US 2017/0147695 A1
(43) Pub. Date: May 25, 2017

(54) METHOD AND SYSTEM FOR MATCHING USERS SERENDIPITOUSLY BASED ON A QUANTUM PROCESSING UNIT

(71) Applicant: Jeanne Louise Shih, Brossard (CA)

(72) Inventor: Jeanne Louise Shih, Brossard (CA)

(21) Appl. No.: 14/948,361

(22) Filed: Nov. 22, 2015

(51) Int. Cl. G06F 17/30; H04L 29/08

(52) U.S. Cl. CPC G06F 17/30867; H04L 67/22; H04L 67/20; G06F 17/3053; G06F 17/30554

(57) ABSTRACT

A system and method for matching people serendipitously in time, with location and within situational context based on computations performed by a quantum processing unit is disclosed. Opportunities for communicating or meeting with candidate matches in a specified context over a network are provided to a user by way of a matching service module. A quantum processor generates distribution states for each user in relation to its candidate matches with potential opportunities to communicate and meet, based on monitored changes associated with the user and the plurality of data collected such as answers the user may give to survey questions, ratings provided by the user, environmental data imported over a network, data by third party applications and data provided by other users over a network. The distribution states, being computed by at least one quantum algorithm embodied on at least one quantum processing unit, and provided for each user represent a suggestion as a possible opportunity to meet with matched candidate serendipitously as determined by the system. The system therefore provides the specified opportunities to meet and engage in time, location and within situational context based on quantum computations and continuously monitors and collects data by computing new opportunities arising from various changes occurring and depending on a given opportunity spaces.

### TECHNICAL FIELD

The present disclosure relates generally to the field of computer implemented artificial intelligence and quantum computing; more particularly to systems and methods for matching people serendipitously based on a quantum processing unit.

### BACKGROUND

Methods known in the art to enable users to meet a candidate match in a specified context such as friendship, courtship or when people have the same interest, include methods that may be dependent on questionnaires, such as open ended or closed ended question and answering or performing comparisons between answers with candidate matches. Other methods known in the art involve having people discover each other based on location, viewing pictures of one another and matching people based on whether one has mutual friends or not. All methods and systems make use of classical computing systems.

What is needed is a system to provide a means for creating serendipitous opportunities for meetings to occur between candidate matches in a networked environment in addition to identifying a successful match. Often times the issue that people have with online or mobile dating services is that online means take away surprise encounters and chance findings that is typically afforded through traditional means, such as meeting someone at the grocery store, or finding love at first sight. Some online services typically sort out an enormous amount of data variables that are judged to be important in determining relationship success and discount what would be called weak associations or less important variables specific to candidate matches as part of the algorithmic filtering. The amount of data variables that could be considered with respect to relationships is large. Other complaints for mobile matching services are that the means for matching people are too objectifying, do not offer enough filters. Some methods target people within a specified location and allow them to swipe through profile pictures and score whether they would like to meet or not. Although this provides an easy communication between candidate matches, it lacks the filtering that may be provided by a more robust matching system. Some people appreciate filtered matching, others are looking for the love-at-first-sight kind of romance found in chance encounters.

### SUMMARY

The present disclosure provides a system and method for determining persons who are likely to have a successful relationship and determining opportunities to meet based on the computations from a quantum processing unit. A quantum processing unit finds optimized solutions according to a large number of weighted and coupled data via a physical unit that mimics quantum processes which is distributive in nature. As a new form of computer where a qubit circuit unit can hold a value of ‘1’ or ‘0’, it is suitable for processing problems such as matching people for relationship purposes as these often involve a large number of possible data sets, with the prospects of introducing chance as part of the solutions, in particular with ever growing data sets. The disclosure herein describes a method for matching and providing the opportunity for serendipitous meetings between people based on a quantum processing unit.

### BRIEF DESCRIPTION OF THE FIGURES

Embodiments of the disclosure will be described by way of example with reference to the accompanying drawings, in which:

FIG. 1 is a flow diagram of an exemplary process for matching a user with candidate matches.

FIG. 2 is an illustrative embodiment of exemplary questions asked for user data collection;

FIG. 3 is an illustrative embodiment of the distributions tabulated according to collected data;

FIG. 4 is an illustrative example of the value factors tabulated by the matching provider for each user at two different times;

FIG. 5 is a block diagram of an exemplary environment for user matching over a network environment;

FIG. 6 is an illustrative embodiment of a user device connected to a matching provider in a network environment;

FIG. 7 is an illustrative example of the matching module provided by the matching provider;

FIG. 8 is an illustrative example of the quantum processing unit embodied by a quantum computer;

FIG. 9 is an example of an objective function equation used to populate the distribution state table in FIG. 10.

FIG. 10 is an example of the distribution state table for four value factors f₂, f₃, f₄, f₅, associated with a list of candidate matches populated for one user;

Similar references used in different Figures denote similar components.

### DETAILED DESCRIPTION

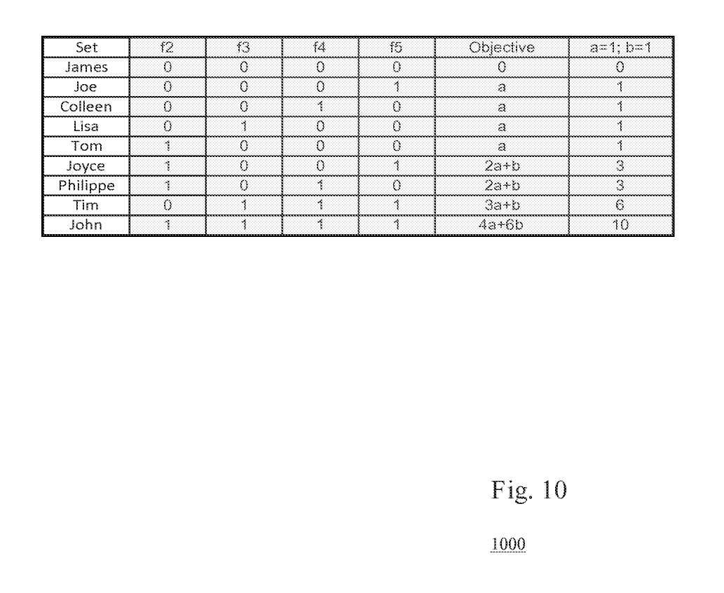

Generally stated, the non-limitative illustrative embodiment of the present disclosure provides a system and method for matching people who are likely to have a successful relationship and in particular, providing opportunities for users to meet in person serendipitously as determined based on the computation from a quantum computing processor unit. A successful relationship means a relationship satisfied within a specified context such as friendship, long term relationship or between people who have the same taste in a product, etc. The user matching is in part determined by data accumulated for each users, such as data resulting from monitored activity data, a survey questionnaire or data from an existing user profile or environmental data associated with the user that may be captured from devices such as gps locators or sensors in a monitored environment. More comprehensive factors, which are explicitly important to each user in conducting the desired relationship, may be determined by accumulating sets of data collected into groups herein called value factors. Value factors are grouped together in time for consideration depending on the type of relationship specified within a defined context, herein called an opportunity space. Users are then matched according to such value factors with their candidate matches by how these value factors assembled according to an opportunity space, fit within the distribution state table of the quantum algorithm used by the quantum processing unit. The possible matches are therefore determined according to data collected about users as well as how the data belonging to candidate matches fit within the quantum computing system that considers the data collected about the specified users and the opportunity space. The system then may explicitly provide communication means between candidate matches to pursue contact, but it also actively monitors the activity of users across a network over time and computes new favorable opportunities with the quantum computing system for meeting any of the determined matches, be it in time or with location or within situational context. Favorable opportunities for meeting candidate matches, who may have had no prior communication or very little, but who may have been determined by the system as having profile elements, such as derived from publicly accessible elements in common, are determined in time or with respect to location for example. Data collected are grouped into value factors and the latter, which are grouped into an opportunity space, are compared between user and candidate matches. Weights for each value factor are assigned for each user and candidate match. Coupler strengths between value factors for each user and candidate match are also assigned. The whole of these is represented as an opportunity space and new ones may be generated with time, location or context. The system may receive data from third party applications providing information about users in order to determine new value factors within a new opportunity space over time and to increment or decrement weight and coupler strengths for value factors. It may also receive data from third party applications providing situational context about a user at a specified location or time, such as whether the user is among a crowd at an event or is having coffee with a friend. The distribution states for possible opportunities to engage with candidate matches using data accumulated from such means are determined according to said collected data, to the distribution states' fit with the quantum algorithm used to compute opportunities by the quantum processing unit. Distribution states of potential opportunities are defined by the candidate matches that fit with the quantum algorithm used, according to the time, location and situational context. In other words, best opportunities are computed in time and according to a specified opportunity space. An opportunity space aims at filtering and specifying the opportunity parameters for a specified user according to data received and according to the fit it has with the data belonging to candidate matches, within a quantum distribution structure, an example of which is presented in FIG. 10. The number and the type of value factors considered may change with time. The opportunity space comprised of specified value factors may be defined by results from computational modeling or may be defined by human curating decisions. The opportunities are communicated to the user in a timely fashion and in accordance with any new profile information, value factors computed or situational context that are available and provided to the system.

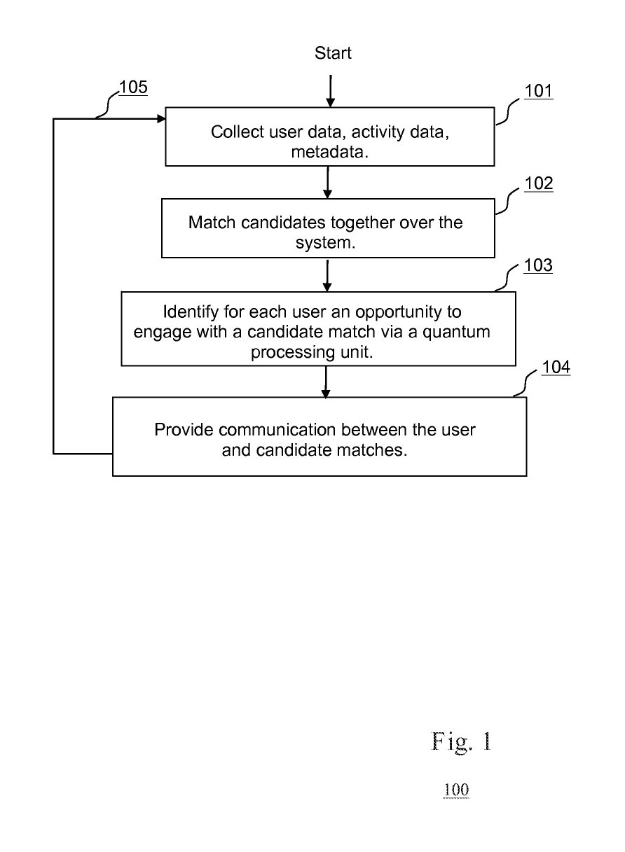

FIG. 1 is a flow diagram 100 of an exemplary process for matching a user with candidate matches over time. At block 101, a plurality of data items is collected as user data, activity data and metadata. User data may include data obtained via profile information, pictures, a survey questionnaire determining personal history in relation to prior relationships or preferences and values for defining a successful relationship, etc. User activity is monitored over the network and a plurality of activity data is collected in a timely manner from a user device, such as location data from a gps detector for example or a body sensor or it may be externally provided data such as metadata associated with a purchased item performed over an external payment system such as item purchased or time of purchase. User data, such as age or for example, information about groups that the user has joined such as a martial arts group, may also be collected about the user from publicly accessible information such as from third party applications where the user may hold a profile. User data from a feed of status updates containing identifiably tagged and time-stamped information about the user may also be collected. For example in December, the user stated the fact that they love sushi; therefore the system may infer that the user in fact loves sushi in the months of December and January. Metadata such as timestamps or location data may also be collected.

At block 102, the system computes distribution sets according to the collected user data, activity data and metadata that are grouped into value factors which are important to a user at that moment in time, at that location, within a given situational context for the purposes of finding a candidate match. A candidate match could be another person with whom the user would like to conduct a long term relationship with. A candidate match could be either male or female. A candidate match could also be a person the user would simply like to see a movie with and be acquainted with for example. A candidate match could also be non-human such as a product. The value factors are the relevant set of variables associated with a user at a given time, at a given location and within a given situational context that define a user's desire to connect for a given reason. The highest candidate matches for a given user are determined.

At block 103, the system computes distribution sets for the best opportunities for a user to meet or engage with a candidate match. These distribution sets are computed according to the value factors determined at block 102 and are computed by a quantum processing unit on a timely basis. Opportunities are therefore meant to be refreshed in time and according to new locations or new situational contexts between a user and a candidate match. Therefore, the collection of user data, activity data and metadata at block 101 may be persistent. In one embodiment, the user may set the level of filtering it desires from the system in providing opportunities or with whom. For example, the user may simply want to meet someone with whom the system has determined he has mutual friends with and is in proximity. Another user may strictly want to meet someone with whom several iterations 105 of analyses and data collection have occurred with positive matches.

At block 104, the system may provide communication between the user and candidate matches. In one embodiment, the degree of communication level may be determined by the system. For example, the communication may simply and only constitute text messages or it may constitute an increasingly open form of communication from a less open form. For example, a user's first communication with a candidate match may begin with a rating on a candidate match's picture, then email communication and by the 5^{th} communication, it may be a video chat. The system may in one embodiment terminate communication between a user and a candidate match if either party requests it. In another embodiment, the communication is restricted to only sending text messages.

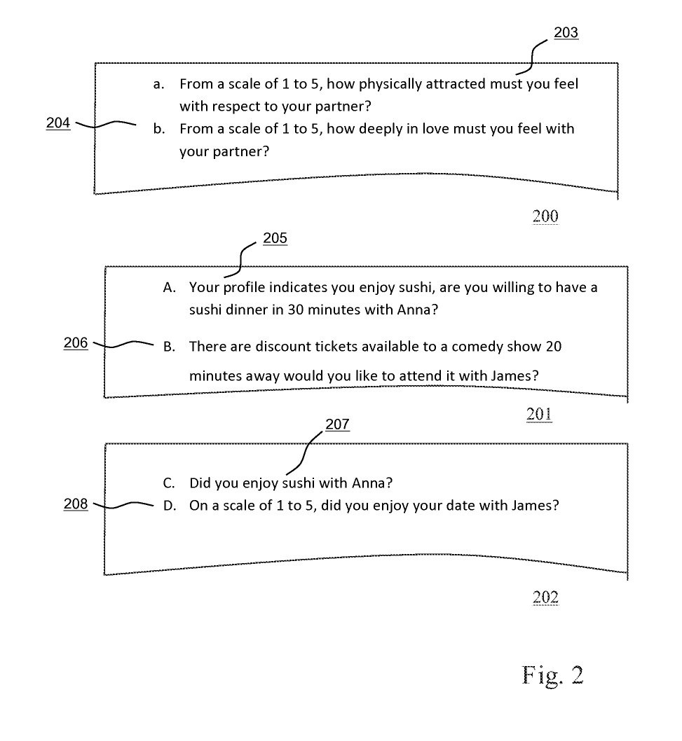

FIG. 2 demonstrates by way of non-limitative example, the type of questions the system may provide the user with in order to collect user data, activity data and metadata. In the preferred embodiment, the data that is collected may be organized into categories. In one embodiment for example, data may be categorized as information that is unlikely to change over time vs information that is likely to change with time. For example, the questionnaire 200 provided to the user may ask the question ‘a’ 203: “From a scale of 1 to 5, how physically attracted must you feel with respect to your partner?” The next question ‘b’ 204 may be: “From a scale of 1 to 5 how deeply in love must you feel with your partner?” Answers to the questionnaire 200 with the questions ‘a’ and ‘b’ would constitute user data that would unlikely change over time. Answers to the questionnaire 201 with the questions ‘A’ 205: “Your profile indicates you enjoy sushi, are you willing to have a sushi dinner in 30 minutes with Anna?” and ‘B’ 206: “There are discount tickets available to a comedy show 20 minutes away, would you like to attend it with James?” however are dependent on the time and the situational context between the user and a candidate match. These may be categorized as information that would likely change over time. Feedback in the form of activity data after the user and candidate match have met may be obtained by asking a third set of questions 202 such as question ‘C’ 207: “Did you enjoy sushi with Anna?” or question ‘D’ 208: “On a scale of 1 to 5, did you enjoy your date with James?”. Metadata such as timestamps may be collected for when the users have attended an event and when they have rated someone for example. In other embodiments, the questionnaires 200, 201, 202 may be embodied in other forms, for example, questionnaire 202 may be a picture of Anna or James and the user is asked to rate them out of 5 stars, after either of the event occurring. In another embodiment a yes or no answer to a question may be embodied by a tactical swipe to the left or right on a mobile phone screen.

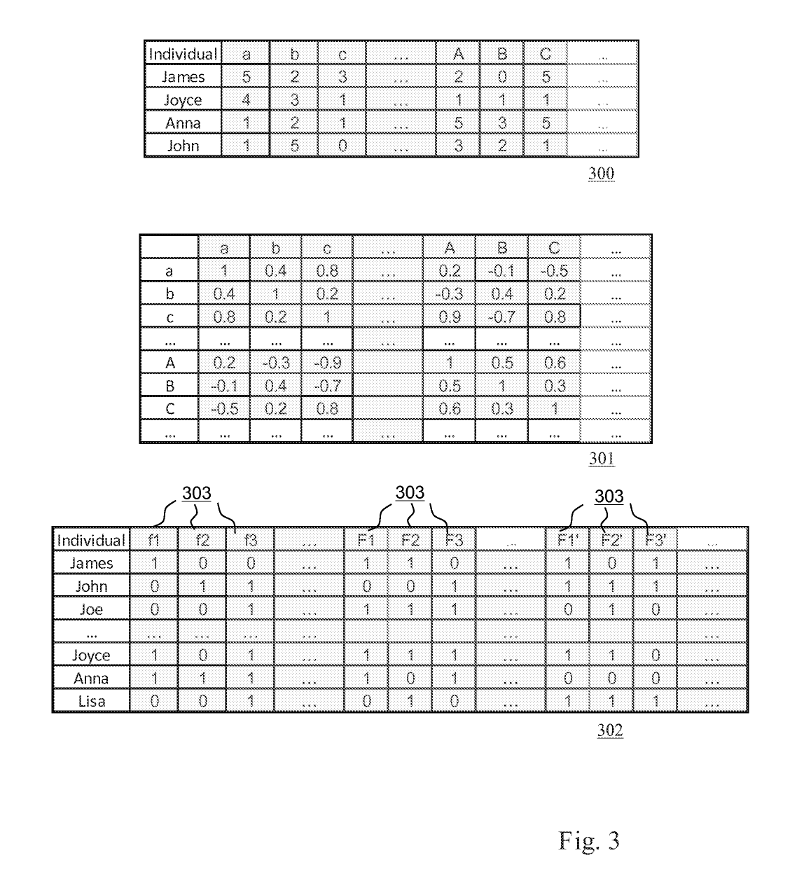

FIG. 3 is a non-limitative embodiment of the factor analysis performed by the system. Table 300 provides a numerical grade to each of the user data, activity data and metadata collected for each user. By way of example, with reference to FIG. 2, James has answered with a 5 for question ‘a’ 203 and with a 2 for question ‘b’ 204 and with a 3 for a question ‘c’. He has also answered with a 2 on question ‘A’ 205 and with a 0 on question ‘13’ and with a 5 on question ‘C’. Similarly, the numerical results for Joyce, Anna and John are populated in table 300. Data, activity data and metadata accumulated by the system for a user is tabulated in a second table 301 which correlates all of the data collected. By way of non-limitative example these include a, b, c categorized as those that are unlikely to change with time and A, B, C those that are ephemeral and may change very quickly with time. Table 300 is a correlation matrix for which the values between the collected data may have been normalized to take on a value of −1 to 1 in one embodiment. The data points with the highest correlation may be combined into a value factor 303 f₁, f₂ or f₃ such as ‘a’ and ‘c’, ‘c’ and ‘A’, ‘c’ and ‘C’, by way of example.

By way of example, if the answer was a 5 for both question ‘a’ 203 and question ‘b’ 204, for one specified user, then the correlation between “feeling deeply in love” and “being physically attracted” is high. Accordingly, the system may assign a “passion” value factor 303 f₁ which therefore include the items, “feeling deeply in love” and “physical attraction”. This value factor 303 f₁ may be assigned a ‘1’ or ‘0’ representing the fact of the value factor 303 being present or absent for any given user or candidate match. A value factor 303 such as that of passion that is absent may be one for which the answer to ‘a’ and ‘b’ were both under 3. By way of exemplary embodiment, table 302 demonstrates that the value factor 303 f₁ is present for James, Joyce and Anna. The opportunity space is defined as the value factors 303 considered for a group of users and candidate matches, for a specified context, that have a set of value factors 303 in common. For example the passion value factor 303 may be considered in the case where candidate matches are connected for relationship purposes; however it may not be considered in the case of matching a user to a certain product.

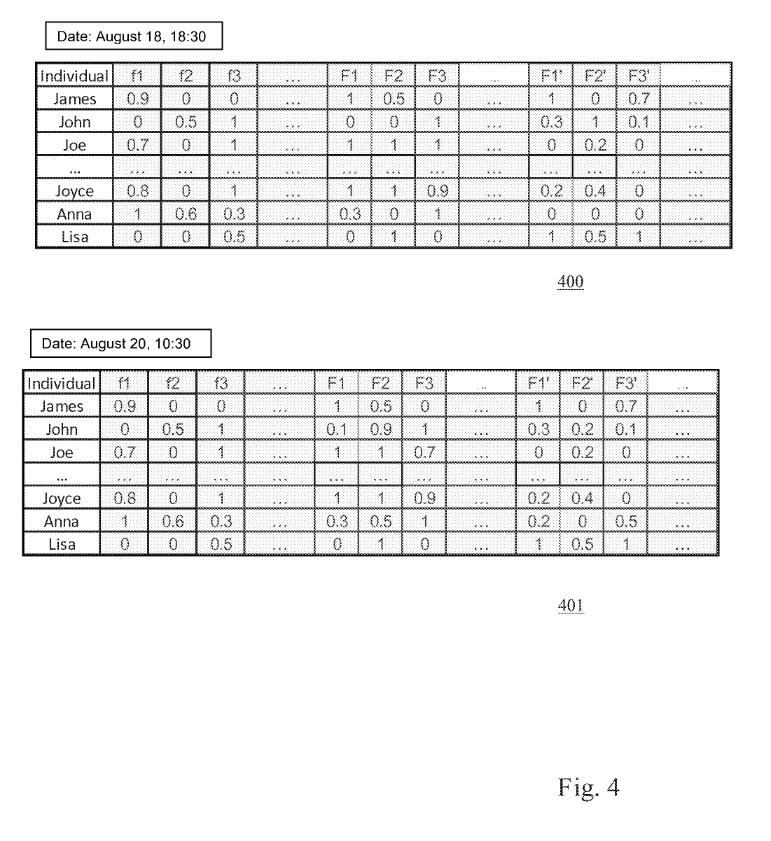

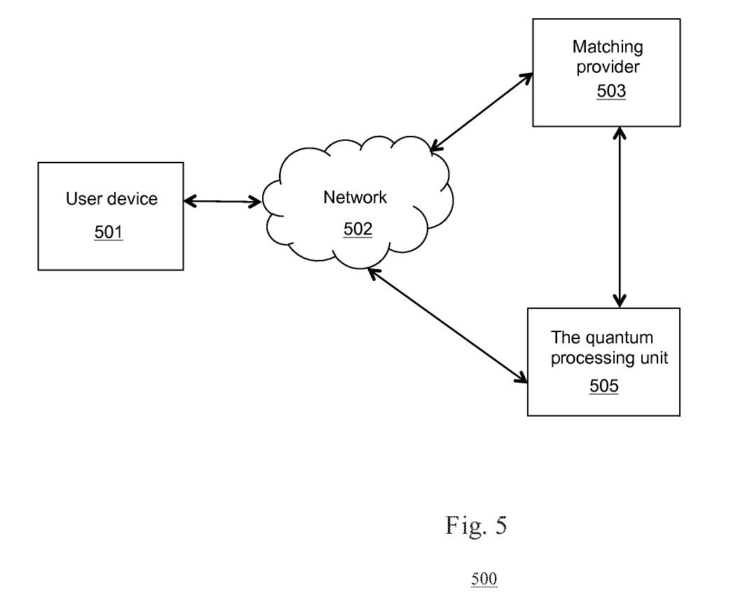

FIG. 4 is a non-limitative embodiment of the distribution state table 400 populated with weights between ‘0’ and ‘1’ assigned to each value factor 303 for a list of users. 401 is the same distribution state table at a later time. The value factors 303 f₁, f₂, f₃ represent value factors 303 that have been categorized as less likely to change with time and may be a result of answers from a survey questionnaire for example. The value factors 303 F₁, F₂, F₃ and F₁′, F₂′, F₃′ are those that have been categorized as likely to change with time, and may for example be a result of collected data from environmental sensor detectors or third party applications or may be location based according to a gps detector for example. Weights may be assigned according to the values from the correlation matrix in one embodiment and may be assigned by human judgment in another embodiment. The potential matches are those that correspond with a specified context. For example at a given moment the matches to be considered are for users with f₁, F₁, F₁′ in table 302 present and the potential matches are those whose distribution states correspond with the objective function equation used by the quantum processing unit 505 in FIG. 5. Several users may have the same distribution states and therefore the system may present several potential opportunities at a given time. The best matches may be those that have the highest values computed by the quantum processing unit 505 in one embodiment. In another embodiment, the best matches may be those candidate matches that have values similar to those computed for the user. In another embodiment, the best matches may be those candidate matches that have computed values similar to those computed for the user and have an additional factor or collected data in common such as being within the same location.

FIG. 5 is a block diagram 500 of an exemplary environment for matching a user on a user device 501 over a network 502 whereby a quantum processing unit 505 is coupled to the matching provider 503 or in communication with it via the network 502. A user device 501 provides a means for the user to interact with the matching provider 503 such as via a mobile application providing the matching service or a web application requesting the user to answer a questionnaire. The user device 501 also provides the means for the matching provider 503 to monitor the user's activity or access data associated with the user in relation to its environment. For example, the user device 501 may be a cell phone, but also include a body sensor or may include a gps locator. The users' activities are monitored and user data associated with users or activity data associated with the environment are accumulated by the matching provider 503 in order to determine the appropriate set of value factors 303 for each user that determine a specified relationship opportunity for that user, and for any type that is being sought. For example the value factors 303 f₁, f₂, f₃ which may be categorized as unlikely to change with time, location and situational context. The value factors 303 that are in common are chosen according to the type of relationship being sought which may depend on strongly held values, or it may depend on a desire to meet someone almost by chance without any prior communication. The candidate matches that are considered are those that at any given time have f₁, F₁, F₁′ present for example and for which its values, together are disturbed in such a way as to satisfy the objective function algorithm used by the quantum processing unit 50. At another time, location and context, the factors to be considered may be F₁, F₂, F₃. In one embodiment, the opportunities may be presented by the matching provider 503 according to value factors 303 F₁, F₂, F₃, F₁′, F₂′, F₃′ that have been categorized as likely to change with time. In another embodiment, in consideration of value factors 303 f₁, f₂, f₃ that are less likely to change with time. In the preferred embodiment, the collection of data, the determination of value factors 303 and the service of determining possible candidate matches is provided by the matching provider 503. The best opportunities in terms of matching candidates and opportunity to engage over a network that may be more based on an element of chance, perceived or not, and in time, with location, within situational context is computed by the quantum processing unit 505 and with a changing set of value factors 303 considered. In another embodiment, the determination of value factors 303 is computed by the quantum processing unit 505.

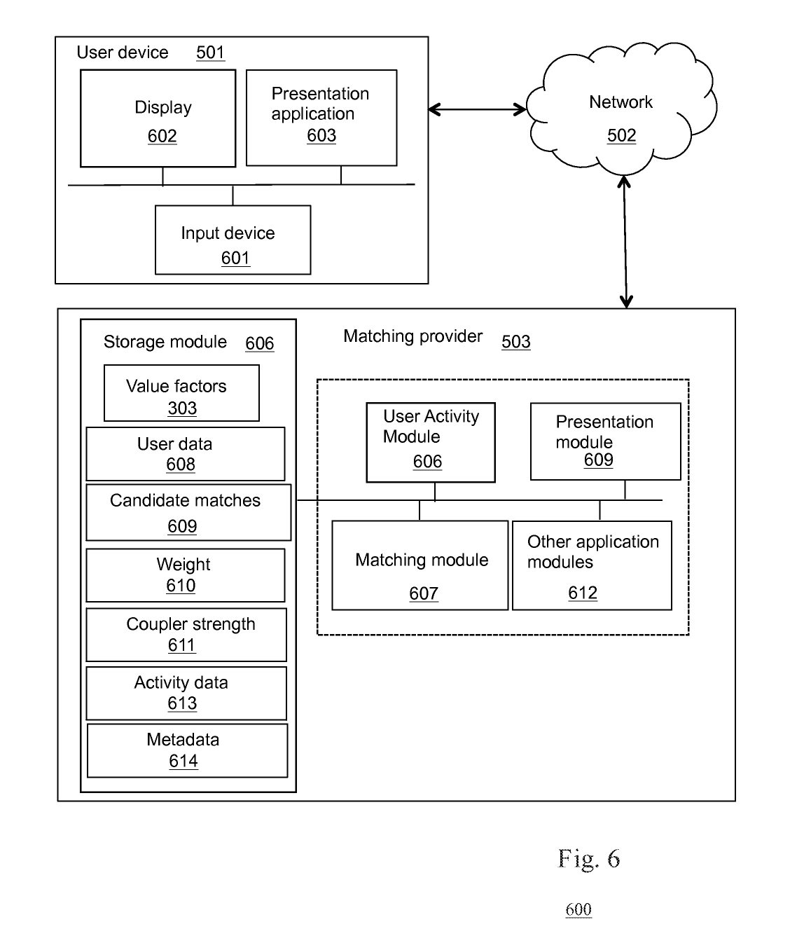

FIG. 6 is a block diagram 600 of the preferred embodiment whereby the matching provider 503 is providing the matching service to the user via the matching module 607 and the user device 501 is in communication with the matching provider 503 via the network 502. The user device 501 is generally operating as an input and presentation device whereby an input device 601 such as a camera or a microphone or keyboard may be capturing a video clip or audio clip or text entered by the user. Presentation of information is provided on the display 602 and handled by the presentation application 603 on the user device 501 and the presentation module 609 serviced by the matching provider 503.

The matching provider module 603 is composed of a user activity module 606 which monitors the user's activity and environment. The user activity module 606 receives user data 608, activity data 613 and metadata 614 associated with the user or with the environment with respect to time, location and situational context. User data 608, activity data 613 and metadata 614 are stored in the storage module 606. These may be automatically updated from external devices such as gps location sensors or other environmental detectors or as part of information provided by third party applications sent to the other application modules 612 through the network 502. Metadata 614 may also be received from other users or devices over a network 502. User data 608, activity data 613 and metadata 614 are processed by the matching module 607 and value factors 303 are determined such as the ones tabulated in 302 of FIG. 3. The value factors 303 are assigned a weight 610 which may be in one embodiment assigned according to answers and ratings provided by the user in a questionnaire, in the form of probabilities, values from a correlation matrix or with regards to the frequency of occurrence, for example the user walking past a location on several occasions. The weight 610 of a value factor 303 may also be assigned according to scarcity, such as in the example of the availability of tickets being scarce at the specified moment where the distribution table is being tabulated for the user and a candidate match in close proximity to one another. Coupler strengths 611 are assigned to value factors 303 that are in common between a user and a candidate match and may be defined by a correlation function, a differential value, etc. By way of exemplary embodiment, in FIG. 4, James and Joyce share value factor 303 F₁′. The differential for the value factor 303 F₁′ between James and Joyce as tabulated in table 400 is 0.8 (1-0.2). A coupler strength 611 for a differential of 0.8 may be assigned a value of 0.2, since James and Joyce's values are far apart, the correlation between James and Joyce with regards to value factor 303 F₁′ is low, the coupler strength is low. Two days later, the differential for the value factor 303 F₁′ between James and Joyce as tabulated in table 401 is 0.1 (1-0.9). Accordingly a coupler strength 611 is assigned a value of 0.9 and is now high.

The user activity module 606 may monitor the user's activity performed via the presentation application module 609 by way of interaction with the presentation application 603 such as clicking on a button, link or access portal, performing a prefix search or time spent viewing a picture. It may also tabulate metadata 614 received from external environmental sensors and detectors in order to determine for example, location or environmental conditions. The user activity module 206 may provide new data in time for the matching module 607 to determine new weights 610 and coupler strength 611 values according to conditional probabilities in one embodiment.

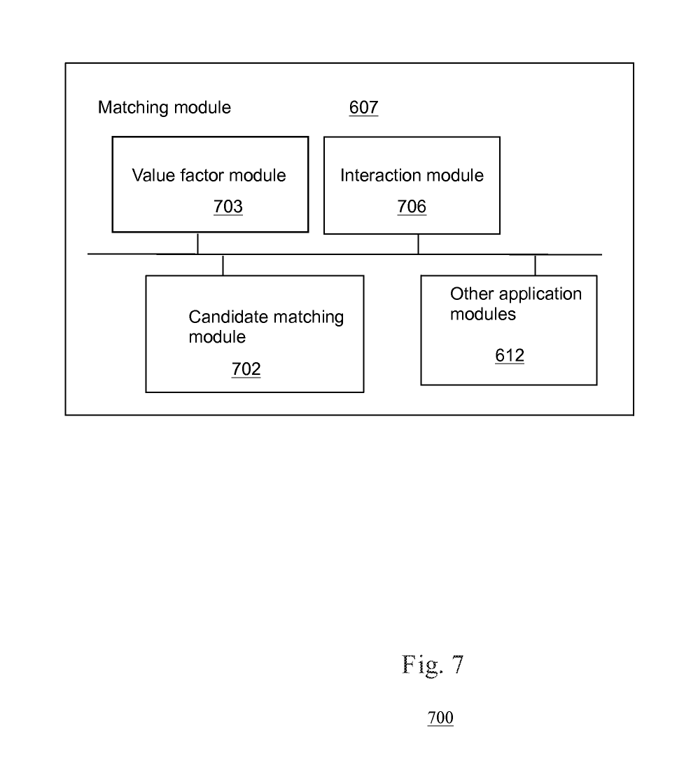

FIG. 7 is an illustrative embodiment of the matching module 607 composed of a value factor module 703 that generates the value factor 303 distribution tables as those provided in FIGS. 3 and 4. The candidate matching module 702 determines the value factors 303 and provides the list of candidate matches 609 associated with the user and matching preferences belonging to each user to be sent to the quantum processing unit 505. The candidate matching module 702 also receives the computed results from the quantum processing unit 505. The interaction module 706 provides info about opportunities for communication between a user and candidate matches according to instruction by the candidate matching module 702. In an alternative embodiment, the matching module 607 is operated by the quantum processing unit 505. In yet another embodiment, some components are operated by the quantum processing unit 505 such as both the value factor module 703 and the candidate matching module 702.

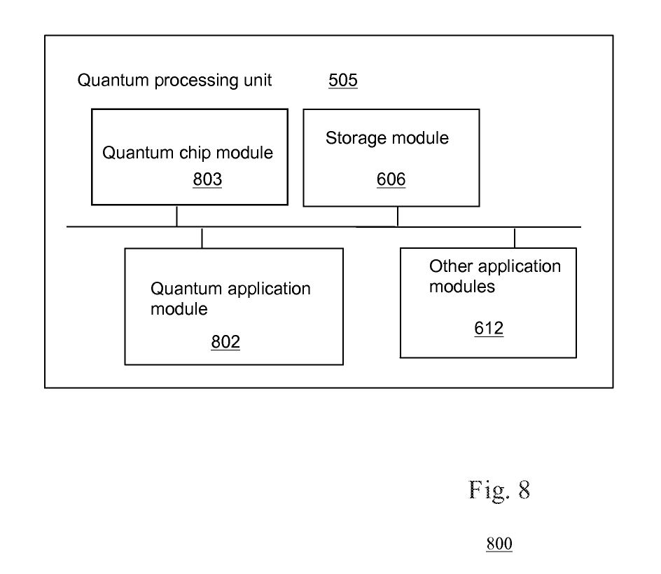

FIG. 8 is an illustrative embodiment of the quantum processing unit 505 that is coupled to the matching provider 503 in the preferred embodiment or in communication with it via the network 502 through the quantum application module 802 in another embodiment. The quantum application module 802 receives data provided by the candidate matching module 702 including the value factors 303, weights 610, coupler strengths 611, candidate matches 609 and programmatically computes via at least one quantum algorithm, distribution states of possible opportunities between a user and its candidate matches 609.

The quantum application module 802 communicates with the quantum chip module 803 to physically map the value factors 303, the weights 610 and coupler strengths 611 into the physical quantum qubits which may take on a value of ‘1’ or ‘0’ and into coupling currents or other physical variables on the at least one quantum chip in the quantum processing unit 505 which may be provided by a company such as D-Wave Systems. The quantum chip module 803 may monitor physical variables such as chip failure or quantum processor chamber condition changes, etc.

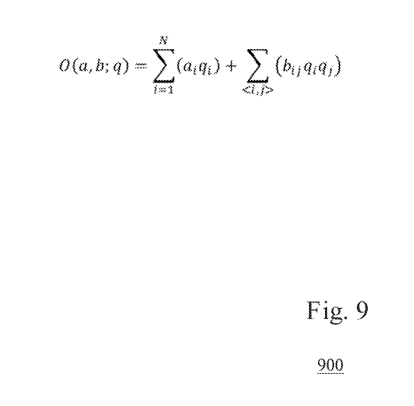

The quantum processing unit 505 therefore programmatically computes via the quantum application module 802 a one or more opportunity between a user and candidate matches 609 provided by the matching module 607 from the matching provider 503. The quantum chip module 803 physically maps the value factors 303, weights 610, coupler strength 611 for a user and its candidate matches 609 to the quantum processing unit 505. The quantum processing unit 505 performs the computation by way of the quantum chip module 803 a one or more opportunity to engage or meet according to at least one objective function equation such as the adiabatic quantum equation in FIG. 9. The one or more opportunities to engage or meet with at least one candidate match 609 is then received by the quantum application module 802. State distributions for the user in relation to each candidate match 609 opportunity at a specified time, location and within a situational context is determined. The opportunity may be to meet in person, send text messages, speak over the phone, assemble as a group, etc.

Referring to FIG. 9, as an exemplary embodiment, the adiabatic quantum annealing objective function equation is used by the quantum processing unit 505 to compute the objective function opportunity values populating the distribution state tables for each user, according to the weights ‘a’ associated with each i^{th} value factor 303 T considered in a given opportunity space and the coupler strengths ‘b’ associated with each i^{th} value factor 303 T for the user and each j^{th} value factor 303 for the candidate match 609. Each i^{th} or j^{th} value factor 303 fᵢ, fⱼ may take on values of either 1 or 0 depending on whether they are present for the user and the candidate match 609. N is the number of value factors 303 considered in the opportunity space. The objective function equation 900 is computed physically by the quantum chip module 803, with fᵢ, fⱼ mapped onto physical quantum qubits and in consideration of all weights 610 and coupler strengths 611 for value factors 303 associated with each user and candidate matches mapped 609 as currents or other circuit design variables. The logical results are represented by the distribution state table 1000 provided in FIG. 10 as a simplified example for when ‘a’ and ‘b’ are equal to ‘’.

Referring to FIG. 10, the distribution table 1000 presents the opportunities tabulated for a user in relation to a list of candidate matches 609. By way of example, the opportunity space being considered takes value factors 303 f₂, f₃, f₄, f₅ for which the system has determined that the users considered are to have f₁ present or all equal to ‘1’, into account and computes via equation 900 the objective function values that are presented in the last column in FIG. 10. By way of example, the weight 610 and coupler strength 611 are simplified to ‘1’. The distribution states computed by the quantum processing unit 505 demonstrate a highest opportunity for the user with John with an objective function value of 10 and a lowest one with James, at that specified time, location and within the situational context at hand. Joe, Colleen, Lisa and Tom hold the same value. In one embodiment, the system may additionally consider these four users in a slightly different opportunity space with new or a longer list of value factors 303 being considered.

The system therefore provides opportunities based on the computations performed with a quantum processing unit 505 and does so over time according to collected user data, activity data 613 and metadata 614 which may change according to environmental changes with time, location and situational context. The system picks the users with the appropriate set of absent and/or present value functions 303 that fit into a distribution table that matches the objective function equation 900 used by the quantum processing unit 505.

Communication with third party APIs or other similar application programs via the other application module 612 may be made through the network 502 and may provide other metadata 614 to the user via matching provider 503. Alternatively third party APIs or other such application programs may be in communication with the matching provider 503 for the purposes of accessing data items that may have been processed and analyzed by the quantum processing unit 505 such as the candidate matches 609 or strictly processed and analyzed by the matching provider 503 or alternatively by both, via the other application module 612.

By virtue of the fact that the system is providing opportunities to several users based on a plurality of value factors 303, weights 610, coupler strengths 611, and in another embodiment, data from third party applications or input from other users over a network, etc, with the intent of providing relevant opportunities with respect to time, location and situational context associated with a network of users and their respective candidate matches 609, the amount of storage for the purposes of tracking changes in such data increases over time. Specifically, for one opportunity having binary values with 10 binary value factors 303 being considered within an opportunity space for a given user and candidate match 609, 2¹⁰=1024 data entries are required. A quantum processing unit 505 is the most suitable in this regard for computing a large and growing set of data, requiring a statistical, distributive methodology such as the one offered by the quantum objective function technique. In other words, the system is rendered more robust by an increase in data entries since it is providing such solutions based on at least one quantum algorithm such as objective function equation 900. The current disclosure therefore provides opportunities for a user in time and over time based on a quantum optimization computation computations for which are physically performed on a quantum processing unit 505.

The situation is further obviated with multiple users over a network 502 and changing value factors 303 that are dependent on several variables such as on user personalities, context and for whom the changes may be taken into consideration by the system from new user data 608 being collected over time. The value factors 303 may also change rapidly with changes in environment according to activity data 613 collected with respect to change in time, location and situational context. The suitability of a quantum processing unit 505 is obviated further if the users and candidate matches 609 are within an opportunity space competing for resources in time and who are tracked for the purposes of calculating the weights 610, coupler strengths 611 and value factors 303 that may be changing significantly with the networked environment or situational context.

In one embodiment, the opportunity space is defined by a physical location space, for example all users within a radius of 2 km who have at least 5 value factors 303 in common are to be considered.

In another embodiment, the opportunity space is defined by an event occurrence, for example all users attending a concert at Carnegie Hall at a specified time who have at least 5 value factors 303 in common are to be considered.

In yet another embodiment, the opportunity space is defined by the number of persons with common value factors 303, irrespective of location, for example all users who have at least 5 value factors 303 in common in Canada and in the United States.

In another embodiment, the opportunity space is defined according to defined variables provided by a third party application via the other application modules 612, such as for example, by a third party application that is sending information related to each user's taste in music.

Although the present disclosure has been described with a certain degree of particularity and by way of an illustrative embodiments and examples thereof, it is to be understood that the present disclosure is not limited to the features of the embodiments described and illustrated herein, but includes all variations and modifications within the scope and spirit of the disclosure as hereinafter claimed.

What is claimed:

1. Accordingly, there is provided a computing device implemented method for matching a user with at least one candidate over a networked environment, the method comprising:
monitoring the user's activity;
receiving a plurality of data in the form of text, video clips, images, audio clips, links or metadata tags from at least one user;
generating at least one determining variable for matching at least two people, a user with an at least one candidate;
associating the at least one determining variable with the user and with the at least one candidate.
generating at least one value factor from at least one determining variable.
associating the at least one value factor with the at least one user and the at least one candidate.
defining the opportunity space by comparing an at least one value factor associated with a user to the at least one value factor associated with an at least one candidate;
assigning a weight to the at least one value factor associated with a user and to the at least one value factor associated with the at least one candidate.
assigning a coupler strength between the at least one value factor associated with a user and with the at least one candidate.
generating via at least one quantum algorithm, at least one opportunity for the user to be matched, communicated with or meet within the defined opportunity space, with an at least one candidate;
providing and displaying the at least one opportunity for the user to be matched, communicated with or meet with the at least one candidate;

2. The method recited in claim 1, further comprising the receiving of the plurality of data is from another user or device across a network or from a third party application or program;

3. The method recited in claim 1, further comprising providing a means for the user to provide feedback after a communication or a meeting with the at least one candidate in the form of text, audio clip, video clip, link, etc.

4. There is further provided a computing implemented system comprising:
a processor;
a recording module configured to cause the processor to monitor one or more user actions;
a matching module configured for:
receiving a plurality of data imported in part from an entry provided by the user, from devices, applications, from associated imported metadata, in the form of text, audio clip, video clip, link, etc;
generating at least one determining variable for matching two people, a user with at least one candidate;
associating the at least one determining variable with the user and with the at least one candidate.
generating at least one value factor from at least one determining variable.
associating the at least one value factor with the at least one user and the at least one candidate.
defining the opportunity space by comparing the at least one value factor associated with a user to the at least one value factor associated with the at least one candidate and determining the matching potential between the user and the at least one candidate;
receiving the at least one user opportunity from a quantum processor unit;
providing and displaying the at least one opportunity for the user to communicate or meet with the at least one candidate to the user;
a quantum processor unit in communication with the matching module, the quantum processor unit configured for:
receiving the at least one value factor, its weights and coupler strength associated with a user and the at least one candidate match from the matching module;
programmatically mapping the at least one value factor, with its weights and coupler strength, associated with a user and the at least one value factor, with its weights and coupler strength, associated with the at least one candidate match both within the defined opportunity space, to physical qubits on at least a one quantum processing chip;
computing the distribution states for the at least one opportunity associated with the at least one candidate match, according to at least one quantum algorithm;
providing the distribution states of the at least one opportunity associated with the at least one candidate match for the user, to the matching module;
a storage medium for storing user data based in part on:
user collected data in the form of text, audio clip, video clip, link, etc;
the at least one candidate match for each user;
the at least one determining variable for each user ;
the at least one value factor for each user;
the at least one weight for each value factor for each user;
the at least one coupler strength of the at least one value factor between a user and the at least one candidate match;
the associated time and activity data in the form of text, audio clip, video clip, link, etc;

5. The system recited in claim 4, further comprising the receiving of the plurality of data is from another user or device across a network or from a third party application or program;

6. The system recited in claim 4, further comprising providing a means for the user to provide feedback after a communication or a meeting with the at least one candidate in the form of text, audio clip, video clip, link, etc.
